(19) United States
(12) Patent Application Publication
(10) Pub. No.: US 2014/0370410 A1
(43) Pub. Date: Dec. 18, 2014

(54) FUEL CELL USING SYNTHETIC JET ARRAY

(71) Applicant: HYUNDAI MOTOR COMPANY, Seoul (KR)

(72) Inventors: Yong Gyu NOH, Suwon-si (KR); Dong Jo OH, Yongin-si (KR)

(73) Assignee: HYUNDAI MOTOR COMPANY, Seoul (KR)

(21) Appl. No.: 14/046,520

(22) Filed: Oct. 4, 2013

(30) Foreign Application Priority Data
Jun. 13, 2013 (KR) 10-2013-0067694

(51) Int. Cl. H01M 8/04

(52) U.S. Cl. CPC H01M 8/04089
USPC 429/444

(57) ABSTRACT

A fuel cell using a synthetic jet array has a structure in which a plurality of cells are superposed in series and share a manifold for inflow and outflow of air, hydrogen, and coolant. The fuel cell includes an air inflow manifold formed passing through the plurality of cells, a synthetic jet array made up of a plurality of jet generators that are disposed on the air inflow manifold at regular intervals and generate a synthetic jet toward a cathode, and a controller configured to selectively operate the jet generators of the synthetic jet array.

### CROSS REFERENCE TO RELATED APPLICATION

This application claims under 35 U.S.C. §119(a) the benefit of Korean Patent Application No. 10-2013-0067694 filed on Jun. 13, 2013, the entire contents of which are incorporated herein by reference.

### TECHNICAL FILED

The present disclosure relates to a fuel cell using a synthetic jet array, capable of reducing non-uniformity of air, hydrogen, and coolant supplies of a stack channel and managing flooding and defective cells.

### BACKGROUND

To improve performance of a fuel cell in a high-current region, a smooth air supply is required. However, in the present fuel cell system, air is supplied using a high-voltage air compressor. If revolutions per minute (RPM) of the compressor is increased to enhance the air supply in a high-output region, power consumption is increased, and efficiency of the entire fuel cell system is reduced.

In addition, due to a limit of an air flow rate itself, the maximum output of the fuel cell is restricted. Thus, a technique of improving the air supply while the RPM of the air compressor is maintained and reducing a loss of concentration in a high-output region to improve the efficiency of the fuel cell is necessary.

Meanwhile, the fuel cell produces electricity using an electrochemical reaction of oxygen and hydrogen. In this process, water is generated as a by-product. The water generated from electrodes is helpful in adjusting relative humidity (RH) of a membrane, but also blocks pores of the electrodes or a gas diffusion layer (GDL), preventing air from being transmitted to the electrodes.

The water generated in such a way cannot be properly removed, and thus, an excessive quantity of water is present in the electrodes and a channel or the GDL, which is called flooding. When the flooding occurs, the transmission of the air and hydrogen is hindered, and the performance of specific cells in a low-output region is sharply reduced. This causes a restriction of the performance of the entire fuel cell. That is, when the flooding occurs, a driver feels a decrease in driving performance or a jolting sensation.

When the flooding occurs in a fuel cell vehicle, water is usually removed by instantly increasing the air flow rate. If the air flow rate is increased, power consumption is high, and a membrane is dried causing a poor durability. For this reason, the flooding may be prevented in advance. A primary cause of the flooding is a non-uniform air supply rather than a shortage of a total quantity of air supplied. Thus, to prevent local flooding, a uniform air supply is required.

The present disclosure is intended to improve such unfavorable conditions by providing an appropriate mechanism and device to a manifold and to greatly enhance performance and stability of a system by implementing more active control.

The foregoing is intended merely to aid in the understanding of the background of the present disclosure, and is not intended to mean that the present disclosure falls within the purview of the related art that is already known to those skilled in the art.

### SUMMARY

The present disclosure provides a fuel cell using a synthetic jet array, capable of reducing non-uniformity of air, hydrogen, and coolant supplies of a stack channel and managing flooding and defective cells.

According to an aspect of the present disclosure, a fuel cell is provided using a synthetic jet array has a structure in which a plurality of cells are superposed in series and share a manifold for inflow and outflow of air, hydrogen, and coolant. The fuel cell includes an air inflow manifold formed passing through the plurality of cells, a synthetic jet array made up of a plurality of jet generators that are disposed on the air inflow manifold at regular intervals and generate a synthetic jet toward a cathode, and a controller configured to selectively operate the jet generators of the synthetic jet array.

When a defective cell of the plurality of cells is detected, the controller may operate the jet generator that is nearest the corresponding defective cell.

When the fuel cell is operated in a high-output section in which an output is equal to or higher than a predetermined output, the controller may operate the jet generators of the synthetic jet array.

In addition, when the fuel cell is operated in a low-output section in which an output is equal to or lower than a predetermined output, the controller may operate the jet generators of the synthetic jet array and control an air compressor so that a stoichiometric ratio is equal to or less than 2.0.

According to another aspect of the present disclosure, a fuel cell using a synthetic jet array has a structure in which a plurality of cells are superposed in series and share a manifold for inflow and outflow of air, hydrogen, and coolant. The fuel cell includes a hydrogen inflow manifold formed passing through the plurality of cells, a synthetic jet array made up of a plurality of jet generators that are provided on the hydrogen inflow manifold at regular intervals and generate a synthetic jet toward an anode, and a controller configured to selectively operate the jet generators of the synthetic jet array.

Here, when a defective cell of the plurality of cells is detected, the controller may operate the jet generator that is nearest the corresponding defective cell.

When the fuel cell is operated in a low-output section in which an output is equal to or lower than a predetermined output, the controller may operate the jet generators of the synthetic jet array.

According to the fuel cell using the synthetic jet array which has the aforementioned structure, the fuel cell can reduce non-uniformity of air, hydrogen, and coolant supplies of a stack channel and manage flooding and defective cells. Particularly, the fuel cell can selectively manage defective cells ensuring an output thereof in whole, prevent flooding of a cathode or an anode to secure durability and prevent oxidation of carbon carriers, and uniformly maintain the coolant flow.

### BRIEF DESCRIPTION OF THE DRAWINGS

The above and other objects, features and other advantages of the present disclosure will be more clearly understood from the following detailed description when taken in conjunction with the accompanying drawings.

FIG. 1 is a graph showing an output state of a defective cell.

FIG. 2 shows a fuel cell using a synthetic jet array according to an embodiment of the present disclosure.

FIG. 3 is a constitutional view of a fuel cell using a synthetic jet array according to an embodiment of the present disclosure.

### DETAILED DESCRIPTION

Hereinbelow, a fuel cell using a synthetic jet array according to an exemplary embodiment of the present disclosure will be described in detail with reference to the accompanying drawings.

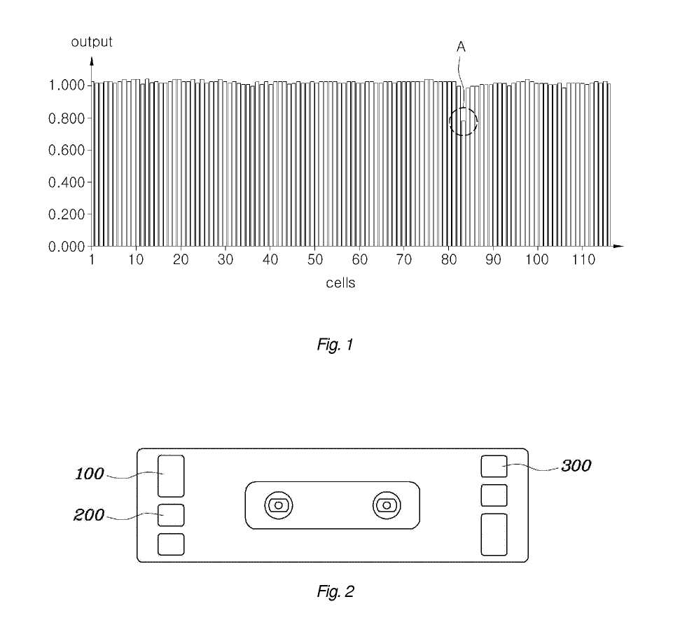

FIG. 1 is a graph showing an output state of a defective cell. Water generated from electrodes in a fuel cell is helpful in adjusting relative humidity (RH) of a membrane, but also blocks pores of the electrodes or a gas diffusion layer (GDL), thus preventing the air from being transmitted to the electrodes.

The water generated such a way is not properly removed, and thus, an excessive quantity of water is present at the electrodes and a channel or the GDL, that is called flooding. Referring to FIG. 1, when the flooding occurs, transmission of the air and hydrogen is hindered, and performance of specific cells in a low-output region is sharply reduced. This causes restriction of performance of the entire fuel cell.

A fuel cell stack used in a vehicle produces high voltage by connecting a number of unit cells in series. If one cell is limited to performance due to a characteristic of the serial connection, the performance of the entire fuel cell is restricted by the cell having the limited performance. That is, when the flooding occurs, a driver feels a decrease in a driving performance or a jolting sensation.

When the flooding occurs in a fuel cell vehicle, water is usually removed by instantly increasing an air flow rate. If the air flow rate is increased, power consumption is high, and the membrane is dried, thereby causing a poor durability. For this reason, the flooding may be prevented in advance. A primary cause of the flooding is a non-uniform air supply rather than a shortage of a total quantity of air supplied. Thus, to prevent local flooding, a uniform air supply is necessary.

Referring to FIG. 1, when the local flooding occurs, a phenomenon in which the output at A of the entirety of cells is remarkably reduced occurs.

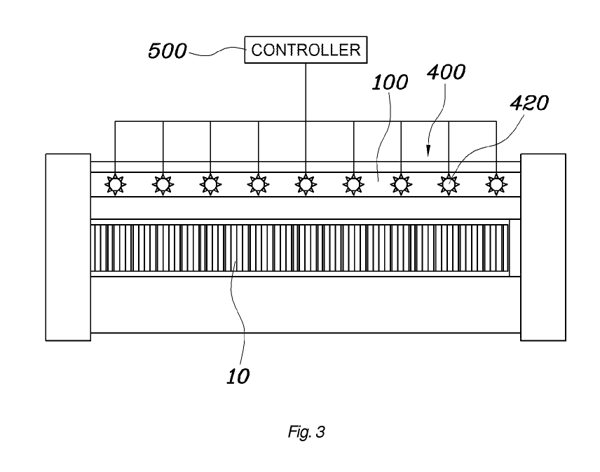

FIG. 2 shows a fuel cell using a synthetic jet array according to an embodiment of the present disclosure. FIG. 3 is a constitutional view of the fuel cell using the synthetic jet array according to an embodiment of the present disclosure. The fuel cell using the synthetic jet array according to an embodiment of the present disclosure has a structure in which a plurality of cells 10 are superposed in series and share a manifold for inflow and outflow of air, hydrogen, and coolant. An air inflow manifold 100 is formed passing through the plurality of cells 10, and a synthetic jet array 400 is made up of a plurality of jet generators 420 that are disposed on the air inflow manifold 100 at regular intervals and generate a synthetic jet toward a cathode. A controller 500 is configured to selectively operate the jet generators 420 of the synthetic jet array 400.

The fuel cell is generally designed so that a plurality of planar cells 10 are superposed in one module and has a structure in which manifold holes for inflow and outflow of air, hydrogen, and coolant passes through the respective cells, and the cells are superposed to form the inflow and outflow manifold of air, hydrogen, and coolant. That is, a series of channels are formed in the superposed cells, and the inflow manifolds of air, hydrogen, and coolant are formed.

The air inflow manifold 100 also has a shape of a channel formed passing through the plurality of cells 10. The air inflow manifold 100 is provided with the synthetic jet array 400. The synthetic jet array 400 is made up of the plurality of jet generators 420 disposed at regular intervals. The jet generators 420 generate a synthetic jet toward a cathode. The controller 500 selectively operates the jet generators 420 of the synthetic jet array.

In detail, the plurality of jet generators 420 shooting the synthetic jet toward the cathode are disposed inside the air inflow manifold 100 and form the synthetic jet array 400. The controller controls the plurality of jet generators 420 to operate all of them at the same time or selectively operate some of them.

The synthetic jet is well disclosed in Korean Patent Application Publication No. 10-2003-0041242 and belongs to a technical means that is already known in the art. Therefore, a detailed description of the synthetic jet will be omitted.

When a defective cell of the plurality of cells is detected, the controller 500 may operate the jet generator 420 that is nearest the corresponding defective cell. Further, when the fuel cell is operated in a high-output section in which an output is equal to or higher than a predetermined output, the controller 500 may operate the jet generators 420 of the synthetic jet array 400. In contrast, when the fuel cell is operated in a low-output section in which the output is equal to or lower than the predetermined output, the controller 500 may operate the jet generators 420 of the synthetic jet array 400 and control an air compressor in a low-level operation mode. The air compressor operates at a low level to supply the air so that a stoichiometric ratio of the fuel cell is equal to or less than 2.0.

The synthetic jet array 400 is disposed on the air inflow manifold 100. To improve structural stability of the array and to minimize obstruction of the air flow, the array is disposed at a dead angle of the manifold and forms the jet toward the cathode.

When the defective cell occurs due to the flooding or other factors, the jet generator 420 adjacent to the defective cell is operated, and an air flow rate of the defective cell is increased. Thereby, the defective cell is restored. When an output is additionally required during an operation of a fuel cell system, the synthetic jet array 400 is operated. Draining of water from the GDL and supplying of oxygen to MEA (membrane-electrode assembly) are improved by the pulse of the air, and efficiency of the stack is increased (a loss of concentration is reduced).

Further, an operation strategy at a less air flow rate in an operation region in which a load is low may be realized, which can greatly reduce the power consumption of the air compressor having the greatest parasitic power in the fuel cell. That is, a capacity of the air supply can be reduced according to its maximum output conditions by reducing an air compression rate.

In addition, a fuel cell using a synthetic jet array according to another embodiment of the present disclosure has a structure in which a plurality of cells 10 are superposed in series and share a manifold for inflow and outflow of air, hydrogen, and coolant. The fuel cell includes a hydrogen inflow manifold 300 formed passing through the plurality of cells 10, a synthetic jet array 400 made up of a plurality of jet generators 420 that are disposed on the hydrogen inflow manifold 300 at regular intervals and generate a synthetic jet toward an anode, and a controller 500 configured to selectively operate the jet generators 420 of the synthetic jet array 400.

When a defective cell of the plurality of cells is detected, the controller 500 may operate the jet generator 420 that is nearest the corresponding defective cell. Further, when the fuel cell is operated in a low-output section in which an output is equal to or lower than a predetermined output, the controller 500 may operate the jet generators 420 of the synthetic jet array 400.

The synthetic jet array 400 is disposed on the hydrogen inflow manifold 300. The array is disposed at a dead angle of the manifold to improve structural stability of the array and to minimize obstruction of a hydrogen flow.

To recirculate the hydrogen required during a low-load operation in the system and to prevent accumulation of condensed water inside an anode channel, the synthetic jet array is operated. The operation of the synthetic jet array generates an amount of recirculation of the hydrogen, thereby complementing a weak point of the low-load operation of an ejector and greatly improving the operation of the stack.

Further, as in the air inflow manifold, when the defective cell occurs (or when the flooding occurs), the synthetic jet array adjacent to the defective cell restores the defective cell.

This constitution may be applied to a coolant inflow manifold 200. In this case, a deviation in a coolant flow rate and a deviation in the coolant speed are checked, and the jet generators may be selectively controlled so that the flow rate or speed of the coolant can be uniformly obtained on the basis of the checked results.

Although an exemplary embodiment of the present disclosure has been described for illustrative purposes, those skilled in the art will appreciate that various modifications, additions and substitutions are possible, without departing from the scope and spirit of the disclosure as disclosed in the accompanying claims.

What is claimed is:

1. A fuel cell using a synthetic jet array, which has a structure in which a plurality of cells are superposed in series and share a manifold for inflow and outflow of air, hydrogen, and coolant, comprising:
an air inflow manifold formed passing through a plurality of the cells;
a synthetic jet array made up of a plurality of jet generators that are disposed on the air inflow manifold at regular intervals and generate a synthetic jet toward a cathode; and
a controller configured to selectively operate the jet generators of the synthetic jet array.

2. The fuel cell according to claim 1, wherein, when a defective cell of the plurality of cells is detected, the controller operates the jet generator that is nearest the corresponding defective cell.

3. The fuel cell according to claim 1, wherein, when the fuel cell is operated in a high-output section in which an output is equal to or higher than a predetermined output, the controller operates the jet generators of the synthetic jet array.

4. The fuel cell according to claim 1, wherein, when the fuel cell is operated in a low-output section in which an output is equal to or lower than a predetermined output, the controller operates the jet generators of the synthetic jet array and controls an air compressor so that a stoichiometric ratio is equal to or less than 2.0.

5. A fuel cell using a synthetic jet array, which has a structure in which a plurality of cells are superposed in series and share a manifold for inflow and outflow of air, hydrogen, and coolant, comprising:
a hydrogen inflow manifold formed passing through the plurality of cells;
a synthetic jet array made up of a plurality of jet generators that are provided on the hydrogen inflow manifold at regular intervals and generate a synthetic jet toward an anode; and
a controller configured to selectively operate the jet generators of the synthetic jet array.

6. The fuel cell according to claim 5, wherein, when a defective cell of the plurality of cells is detected, the controller operates the jet generator that is nearest the corresponding defective cell.

7. The fuel cell according to claim 5, wherein, when the fuel cell is operated in a low-output section in which an output is equal to or lower than a predetermined output, the controller operates the jet generators of the synthetic jet array.
